(19) United States
(12) Patent Application Publication
(10) Pub. No.: US 2023/0127337 A1
(43) Pub. Date: Apr. 27, 2023

(54) STANDING-UP ASSIST DEVICE

(71) Applicant: HONDA MOTOR CO., LTD., Tokyo (JP)

(72) Inventors: Tomohiro Tsukamoto, Wako-shi (JP); Tomoyuki Nemoto, Wako-shi (JP); Takeshi Koshiishi, Wako-shi (JP)

(21) Appl. No.: 17/952,974

(22) Filed: Sep. 26, 2022

(30) Foreign Application Priority Data
Oct. 22, 2021 (JP) 2021-173446

(51) Int. Cl. A61G 7/10

(52) U.S. Cl. CPC A61G 7/1019; A61G 7/1017; A61G 2200/34; A61G 7/1046

(57) ABSTRACT

A standing-up assist device includes: a base portion; a shaft portion extending upward from the base portion, the shaft portion being expandable and contractible; and a support portion, provided at an upper end portion of the shaft portion, for supporting a body of a user, in which the shaft portion has a plurality of shaft members arranged in a front-rear direction.

### INCORPORATION BY REFERENCE

The present application claims priority under 35 U.S.C. § 119 to Japanese Patent Application No. 2021-173446 filed on Oct. 22, 2021. The content of the application is incorporated herein by reference in its entirety.

### BACKGROUND OF THE INVENTION

### Field of the Invention

The present invention relates to a standing-up assist device.

### Description of the Related Art

A user with weak knees, legs and hips needs a great deal of effort to stand up from a state of sitting on a sitting chair by himself/herself, which puts a heavy load on the body. Accordingly, devices for assisting in standing up from sitting chairs have been proposed. Japanese Patent No. 5773718 and Japanese Patent No. 6737796 disclose a device, as a device in this category, including a base portion and a shaft portion that is expandable and contractible in an up-down direction with respect to the base portion, in which a member gripped by the user or a member holding the user is arranged on the upper side of the shaft portion, and the shaft portion is expanded and contracted to assist the user in standing up.

However, the conventional device has room for improvement in terms of balance stability when the user applies a load to the support portion.

An object of the present invention is to provide a standing-up assist device capable of further enhancing balance stability.

### SUMMARY OF THE INVENTION

One aspect of the present invention is a standing-up assist device, including: a base portion; a shaft portion extending upward from the base portion, the shaft portion being expandable and contractible; and a support portion, provided at an upper end portion of the shaft portion, for supporting a body of a user, wherein the shaft portion has a plurality of shaft members arranged in a front-rear direction.

According to one aspect of the present invention, the balance stability can be further enhanced.

### BRIEF DESCRIPTION OF THE DRAWINGS

FIG. 1 is a perspective view showing an overall configuration of a standing-up assist device;

FIG. 2 is a diagram showing a movable mechanism of the standing-up assist device;

FIG. 3 is a diagram schematically showing a trajectory of a support portion when a shaft portion of the standing-up assist device moves;

FIG. 4 is a block diagram showing a functional configuration of a control system related to movement control of the standing-up assist device; and

FIG. 5 is a diagram schematically showing a correspondence between: a movement of a healthy person who does not need assistance in standing up; and a fourth trajectory.

### DETAILED DESCRIPTION OF THE PREFERRED EMBODIMENT

An embodiment of the present invention will now be described with reference to the drawings.

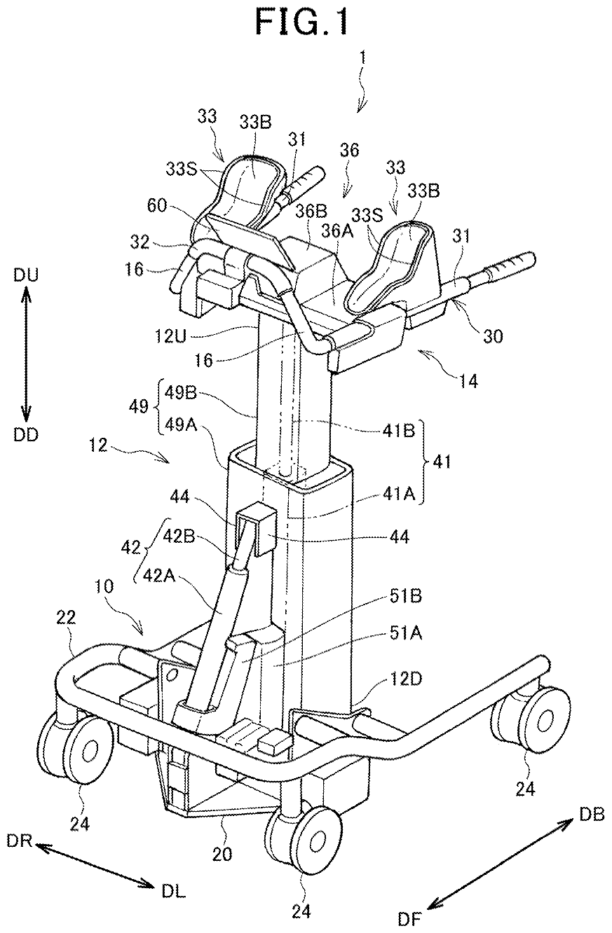

FIG. 1 is a perspective view showing an overall configuration of a standing-up assist device 1 according to the present embodiment.

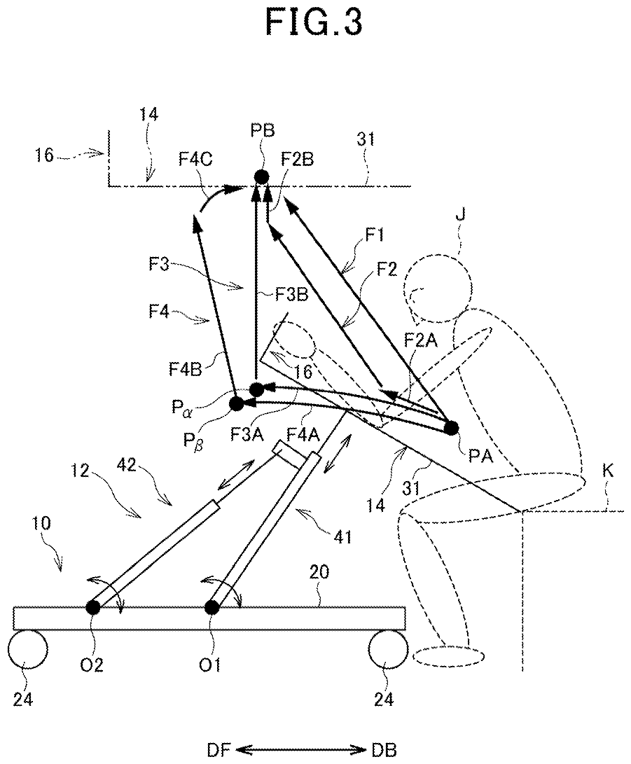

The standing-up assist device 1 is a device for assisting standing-up motion and sitting-down motion of a user J (see FIG. 3). The standing-up motion represents a motion in which the user J keeps the direction of the body and stands up from a sitting state, in which the user J sits on a seat K (see FIG. 3) such as a chair or a bed, to a standing state, in which the user stands up. The sitting-down motion represents a motion in which the user J keeps the direction of the body and lower the hips to sit down on the seat K to shift from the standing state to the sitting state.

In the following description, the direction in which the user J in the sitting state stands up in the standing-up motion is referred to as a front direction DF, and the direction in which the user J in the standing state moves the hips (buttocks) in the sitting-down motion is referred to as a rear direction DB. Of the directions orthogonal to the front direction DF and the rear direction DB, the side where the left hand of the user J facing the front direction DF is located is referred to as the left direction DL, and the side where the right hand of the user J is located is referred to as the right direction DR. The upward direction in the vertical direction is referred to as an upward direction DU, and the downward direction in the vertical direction is referred to as a downward direction DD.

In addition, the movement of the body when a healthy person who does not need assist performs a standing-up motion and a sitting-down motion is referred to as a “natural motion”.

The standing-up assist device 1 of the present embodiment includes a configuration for assisting the user J to perform a standing-up motion and a sitting-down motion with a motion close to the natural motion. Since the user J performs standing-up motion and sitting-down motion with a movement close to the natural motion, he/she can stand up and sit down by appropriately using his/her own power without overly relying on assist.

The structural configuration of the standing-up assist device 1 will now be described.

FIG. 1 is a perspective view showing an overall configuration of a standing-up assist device 1.

As shown in the figure, the standing-up assist device 1 includes a base portion 10, a shaft portion 12, a support portion 14, and grip portions 16.

The base portion 10 corresponds to the base part of the structure (skeleton) of the standing-up assist device 1, and includes a base plate 20 that is a main frame on which the shaft portion 12 is erected. Further, the base portion 10 of the present embodiment includes: a pipe frame 22 having a substantially C-shape in a plan view and an opening in the rear direction DB; and wheels 24 movably supporting the pipe frame 22, and the base plate 20 is supported by the pipe frame 22 inside the pipe frame 22. Wheels 24 are provided on the left and right of the front end of the pipe frame 22 and the other wheels 24 are provided on the left and right of the rear end thereof, contributing to stably balancing the standing-up assist device 1 in the front-rear direction and the left-right direction. Since the respective wheels 24 are casters that can move in any direction, and the standing-up assist device 1 includes such wheels 24, the standing-up assist device 1 moves according to the walking of the user J in the standing state, and can be used for a device called a walk assist device.

The shaft portion 12 is a part having a shape extending from the base portion 10 in the upward direction DU, the lower end portion 12D thereof is coupled to the base plate 20 of the base portion 10, and the upper end portion 12U thereof is fixed to the support portion 14. In other words, the shaft portion 12 also functions as a part supporting the support portion 14 in the upward direction DU of the base portion 10. The shaft portion 12 is turnable in the front-rear direction around the lower end portion 12D and is expandable and contractible in an up-down direction, whereby the support portion 14 can be moved in both the front-rear direction and the up-down direction. The configuration of the shaft portion 12 is to be described below.

The support portion 14 is a part supporting the body of the user J, and the support portion 14 of the present embodiment includes a rod-shaped member 30 having a substantially C-shape in a plan view and an opening in the rear direction DB. Specifically, the rod-shaped member 30 has a pair of left and right elbow contact portions 31 extending in the front-rear direction, and a connecting portion 32 connecting the front end portions of the respective elbow contact portions 31. Each elbow contact portion 31 is a part for supporting the elbow of the user J, and is provided with a cup-shaped elbow contact support member 33 into which the elbow is fitted. The elbow contact support member 33 has a pair of left and right side walls 33S and a rear wall 33B located in the rear direction DB of the elbow, the side walls 33S prevent the elbow from moving in the left-right direction, and the rear wall 33B supports the elbow from the rear direction DB.

Further, the support portion 14 is provided with a pair of the left and right grip portions 16 that are parts to be gripped by the user J by hand. In the present embodiment, the grip portions 16 are integrated with the rod-shaped members 30 constituting the support portion 14. Specifically, the rod-shaped members 30 each have a part bent upward at the front end portion of each of the left and right elbow contact portions 31, and these parts constitutes the grip portions 16.

Note that members each having a shape that can be gripped by the user J (for example, a rod-shaped members) may be erected on the respective elbow contact portions 31 to form grip portions 16 separately from the rod-shaped members 30 constituting the support portion 14. Further, the mounting positions of the elbow contact support members 33 may be configured to be adjustable in the front-rear direction according to the length from the hand to the elbow of the user J. As a result, the user J can adjust the mounting positions of the elbow contact support members 33 so that he/she can always grip the grip portions 16 while putting the elbows in the elbow contact support members 33.

Further, the support portion 14 is provided with a chest contact support portion 36 between a pair of the left and right elbow contact portions 31. The chest contact support portion 36 includes a plate material 36A installed between a pair of the left and right elbow contact portions 31 and a protruding chest contact material 36B fixed to substantially the center of the left and right sides of the plate material 36A, and substantially the entire chest contact support portion 36 including the chest contact material 36B is covered with a member having resilience such as urethane foam. When the user J is in a standing state or in a forward-bent posture, he/she can press the chest against the chest contact support portion 36 to support the upper body.

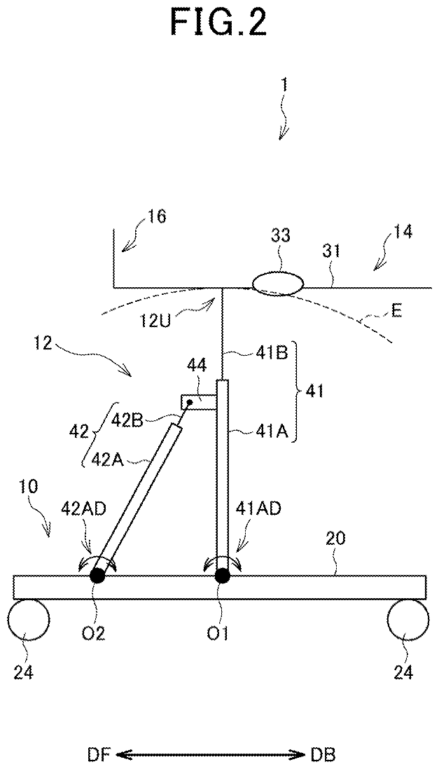

FIG. 2 is a diagram showing a movable mechanism of the standing-up assist device 1. Note that FIG. 2 is a schematic diagram, and the dimensions, shapes, and positions of the members are different from those in FIG. 1.

The shaft portion 12 of the standing-up assist device 1 includes a first shaft member 41 and a second shaft member 42, each of which is expandable and contractible in the up-down direction, and has a lower end portion coupled to the base portion 10. In the present embodiment, the first shaft member 41: includes an outer cylinder 41A having a hollow cylindrical shape, and a rod 41B housed coaxially with and linearly movably in the outer cylinder 41A; and has a linear motion device that expands and contracts as a whole when the rod 41B linearly moves back and forth. Similarly, the second shaft member 42: includes an outer cylinder 42A having a hollow cylindrical shape and a rod 42B housed coaxially with and linearly movably in the outer cylinder 42A; and has a linear motion device that expands and contracts as a whole when the rod 42B linearly moves back and forth. In the present embodiment, these linear motion devices each use an electric cylinder having a ball screw and a motor for driving the ball screw to rotate. The movement in assisting the standing-up motion and the movement in assisting the sitting-down motion, which is a movement substantially opposite to the standing-up motion, are in a substantially forward-to-reverse relationship; and using a cylinder having a ball screw and a motor for the linear motion device makes it possible to easily implement the forward and reverse movement and to perform positioning and speed control. Here, the linear motion device can use a well-known or known mechanism having other configurations.

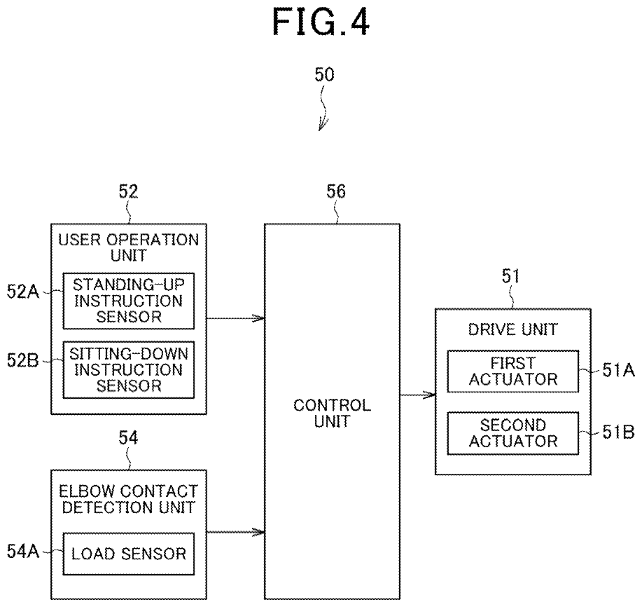

The first shaft member 41 and the second shaft member 42 are arranged side by side in the front-rear direction; the respective outer cylinders 41A and 42A are provided on the base portion 10 (base plate 20) so as to be turnable in the front-rear direction; and the first shaft member 41 and the second shaft member 42 are individually driven respectively by the first actuator 51A and the second actuator 51B (see FIGS. 1 and 4). In the present embodiment, the first shaft member 41 and the second shaft member 42 respectively have the lower end portion 41AD and 42AD each turnably and pivotally supported by the base portion 10, providing the turning shafts O1 and O2 for the respective turns at the lower end portions 41AD and 42AD.

Here, the end of the rod 41B of the first shaft member 41 corresponds to the upper end portion 12U of the shaft portion 12, and the support portion 14 is fixed to the end. As a result, the support portion 14 moves along an arc E centered on the turning shaft O1 with the turn of the first shaft member 41 at the height position supported by the first shaft member 41. The length of the arc E increases in proportion to the length (height) of the first shaft member 41 which is the turning radius. This configuration can make the movable range of the support portion 14 greater than, for example, configurations as in the above Patent Literature 1 and Patent Literature 2 in which a support portion is turnably supported by an end of a shaft portion erected on a base portion so as not to be turnable.

Further, the fixing point (upper end portion 12U of the shaft portion 12) between the support portion 14 and the first shaft member 41 is fixed by fastening means such as welding, bolts, or screws, so that the support portion 14 is not turnable with respect to the shaft portion 12. This can prevent the user from injury on his/her wrist caused in such a way that the support portion 14 unintentionally turns with respect to the shaft portion 12 while the user grips the grip portions 16, and the force of the turn acts on the user's wrist.

The second shaft member 42 has a rod 42B, an end of which is turnably coupled to the outer cylinder 41A, which is a non-movable portion of the first shaft member 41. Specifically, as shown in FIG. 1 above, the outer cylinder 41A of the first shaft member 41 is provided with a pair of left and right plate-shaped coupling pieces 44; and as shown in FIG. 2, the end of the rod 42B of the second shaft member 42 is pivotally supported by the coupling pieces 44 with a pin or the like. This causes the end to passively turn according to the turn, and expansion and contraction of the first shaft member 41 and the second shaft member 42.

In the present embodiment, as shown in FIG. 1 above, the standing-up assist device 1 includes a cover member 49 covering the entire circumference of the first shaft member 41 to improve the sense of stability and prevent looseness; and the second shaft member 42 is coupled to the first shaft member 41 via the cover member 49. Specifically, the cover member 49 internally includes the outer cylinder 41A of the first shaft member 41, and includes a first cover member 49A that is immovable with respect to the outer cylinder 41A and a second cover member 49B that internally includes the rod 41B. The first cover member 49A has the coupling pieces 44 to which the end of the rod 42B of the second shaft member 42 is coupled.

FIG. 3 is a diagram schematically showing a trajectory of the support portion 14 when the shaft portion 12 of the standing-up assist device 1 moves.

In the standing-up assist device 1, the first shaft member 41 turns on the turning shaft O1 at the lower end portion 41AD and expands and contracts in the up-down direction, so that the support portion 14 is movable in various trajectories between a position PA corresponding to the user J in the sitting posture (hereinafter referred to as a sitting position) and a position PB corresponding to the user J in the standing posture (hereinafter referred to as a standing position). As shown in FIG. 3, such trajectories include a first trajectory F1, a second trajectory F2, a third trajectory F3, and a fourth trajectory F4.

The first trajectory F1 is a trajectory diagonally and linearly connecting the sitting position PA and the standing position PB.

The second trajectory F2 is a trajectory in which the first trajectory F1, diagonally linearly extending, additionally includes a section F2A extending to the front F1 at the start of the standing-up motion, and a section F2B extending straight up at the end of the standing-up motion.

The third trajectory F3 is different from the first trajectory F1 and the second trajectory F2, and is a trajectory hardly including a trajectory extending linearly in the diagonal direction. In other words, the third trajectory F3 is a trajectory consisting of a section F3A extending from the sitting position PA to a position Pα directly under the standing position PB and a section F3B extending from the position Pα directly thereunder to the standing position PB right above.

The fourth trajectory F4 is a trajectory consisting of: a section F4A extending in the front direction DF from the sitting position PA to a predetermined front end position Pβ beyond the position Pα directly under the standing position PB; a section F4B linearly extending diagonally upward and forward from the predetermined front end position Pβ; and a section F4C extending from the upper end of the moving trajectory F4 to the standing position PB.

The fourth trajectory F4 is a trajectory corresponding to the above natural motion, and the relationship between the fourth trajectory F4 and the natural motion is to be described below.

FIG. 4 is a block diagram showing a functional configuration of a control system 50 related to the movement control of the standing-up assist device 1.

The standing-up assist device 1 includes a drive unit 51, a user operation unit 52, an elbow contact detection unit 54, and a control unit 56.

The drive unit 51 drives the shaft portion 12 to rotate, expand and contract, and includes the first actuator 51A and the second actuator 51B, which are drive sources for the first shaft member 41 and the second shaft member 42, respectively. As shown in FIG. 1 above, the first actuator 51A and the second actuator 51B are arranged at the lower end portions 41AD and 42AD of the first shaft member 41 and the second shaft member 42, respectively. This lowers the center of gravity of the standing-up assist device 1, and improves the stability. Note that the first actuator 51A and the second actuator 51B can be arranged anywhere, for example, at a position near the lower end portions 41AD and 42BD as long as the actuators are closer to the lower end portions 41AD and 42AD of the first shaft member 41 and the second shaft member 42, respectively, and the position is a position to lower the center of gravity.

The user operation unit 52 is a part that the user J operates to receive assist for the standing-up motion and the sitting-down motion, and includes an operation detection device for receiving the operation and outputting the operation to the control unit 56. In the present embodiment, the operation detection device of the user operation unit 52 includes: momentary switches, which is an example of an operation input device, for operation input for receiving assist for standing-up motion and operation input for receiving assist for sitting-down motion; and a standing-up instruction sensor 52A and a sitting-down instruction sensor 52B for detecting the operation input of each momentary switch. In the present embodiment, both the momentary switches are disposed on the support portion 14. Specifically, the grip portion 16 on the right hand side is provided with a momentary switch corresponding to assisting the standing-up motion, and the grip portion 16 on the left hand side is provided with the momentary switch corresponding to assisting the sitting-down motion.

The elbow contact detection unit 54: detects that the user J is ready to receive assist in a standing-up motion or a sitting-down motion when he/she takes a posture in which he/she sufficiently presses the elbow against the elbow contact support member 33, based on the load applied to the elbow contact support member 33; includes a load sensor 54A arranged on the elbow contact support member 33; and outputs the detection information to the control unit 56.

The control unit 56 controls the drive unit 51 according to the operation of the user J on the user operation unit 52. Specifically, the control unit 56 controls the drive unit 51 to move the support portion 14 from the sitting position PA to the standing position PB when the standing-up instruction sensor 52A detects the standing-up instruction. Further, the control unit 56 controls the drive unit 51 to move the support portion 14 from the standing position PB to the sitting position PA when the sitting-down instruction sensor 52B detects the sitting-down instruction. However, when the control unit 56 determines that the predetermined load is not applied to the elbow contact support member 33 and the user J does not sufficiently press the elbow against the elbow contact support member 33, based on the detection information of the elbow contact detection unit 54, the control unit 56 does not drive the drive unit 51 if the user operation unit 52 is operated. This can prevent an event such that, in a state in which the user J is not in a posture to receive assist for the standing-up motion or the sitting-down motion, the support portion 14 moves so that only the hand of the user J who grips the grip portion 16 is drawn to the movement of the support portion 14 and the torso cannot keep up with the movement (for example, in assisting the standing-up motion, the torso remains on the side of the seat K).

The control unit 56: has a computer including a processor such as a CPU or MPU, a memory device such as a ROM or RAM, a storage device such as an HDD or SSD, and an input/output circuit for connecting sensors and peripheral devices; and implements various functions by the processor executing computer programs stored in a memory device or a storage device.

In addition to the above-described configuration, the standing-up assist device 1 also includes: a display device 60 (FIG. 1) for displaying various information and presenting it to the user J; and an input device for inputting various information to the control unit 56.

Here, in the standing-up assist device 1 of the present embodiment, when the user J instructs assist in the standing-up motion and the sitting-down motion, the control unit 56, in any of the instructions, controls the drive unit 51 (each of the first actuator 51A and the second actuator 51B) to move the support portion 14 along the fourth trajectory F4, to assist the movement so that the user J stands up or sits down with a movement close to the natural motion.

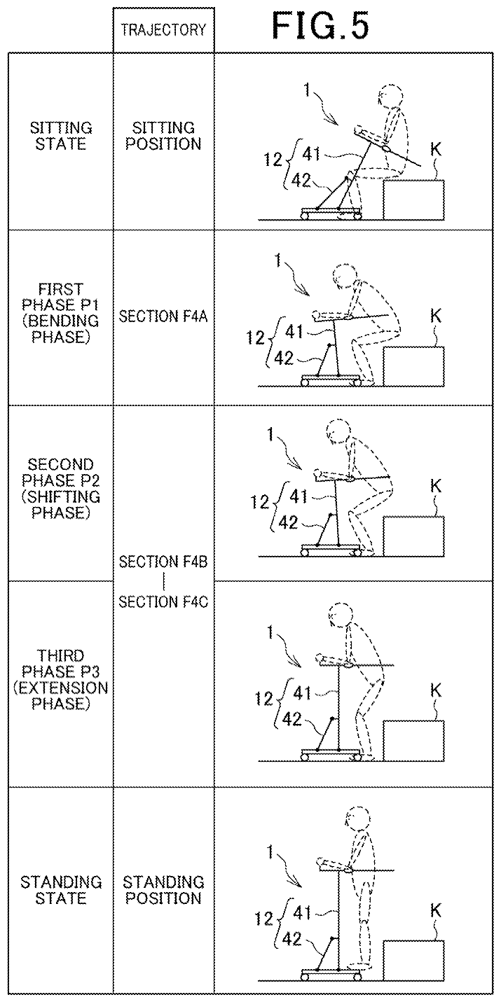

FIG. 5 is a diagram schematically showing a correspondence between the movement of a healthy person who does not need assist in standing up and the fourth trajectory F4. When a healthy person sits down, the movement thereof is almost the same as the movement rewinding the movement in standing up.

As shown in the same figure, the movement in standing up includes the following three phases while a healthy person shifts from the sitting state to the standing state: a first phase P1, a second phase P2, and a third phase P3. The first phase P1 is a phase (bending phase) in which a healthy person lifts his/her hips from the seat K and bends his/her body so as to bend forward, and moves his/her center of gravity toward the front direction DF. The second phase P2 is a phase (shifting phase) in which a healthy person raises his/her upper body. The third phase P3 is a phase (extension phase) in which a healthy person extends his/her knees, and legs and hips.

On the other hand, as shown in FIG. 3 above, the fourth trajectory F4 includes three sections F4A, F4B, and F4C. As shown in FIG. 5, the section F4A (first section) corresponds to the movement of the first phase P1, and the two sections (second section) of the sections F4B and F4C correspond to the movement of the second phase P2 and the third phase P3.

Specifically, as described above, the section F4A is: a trajectory in which the support portion 14 moves from the sitting position PA to the predetermined front end position Pβ in the front direction DF beyond the position Pα directly under the standing position PB; and a trajectory in which the support portion 14 moves according to the movement of the body when the user J bends forward in the first phase P1. In the present embodiment, the front end position of the section F4A is set to a position where the first shaft member 41 inclines toward the front direction DF at a predetermined angle between about 10 degrees and about 20 degrees with respect to the vertical direction.

Further, the two sections F4B and F4C are: trajectories in which the support portion 14 moves from the predetermined front end position Pβ to the standing position PB; and trajectories in which the support portion 14 moves according to the movement of the body when the user J raises the upper body and extends the knees and hips in the second phase P2 and the third phase P3.

In this way, the movement of the support portion 14 along the fourth trajectory F4 allows the user J to perform a standing-up motion and a sitting-down motion with a motion close to a natural motion, and thereby allows the user to stand up and sit down by using his/her own power moderately without overly relying on assist. This provides appropriate assist for users who need a relatively light assist.

The standing-up assist device 1 may be able to set each of the first trajectory F1 to the fourth trajectory F4 for each user J, and the control unit 56 may control the drive unit 51 so that the support portion 14 moves along the trajectory corresponding to the user J.

Here, as shown in FIG. 1 above, the standing-up assist device 1 includes the shaft portion 12 having two shaft members, a first shaft member 41 and a second shaft member 42. The two shaft members are installed side by side in the front-rear direction, to improve stability degree in the front-rear direction. As a result, if the user J bends forward and a load to the front direction DF is applied to the support portion 14 in the first phase P1 (section F4A), it is also possible to prevent a part of the base portion 10 on the rear direction DB side (wheels 34 located in the rear direction DB) from rising, and enhance the balance stability. Further, since the torque received by the shaft portion 12 can be dispersed to the first shaft member 41 and the second shaft member 42, a larger torque can be received.

When the support portion 14 moves beyond the position directly under the standing position PB and further moves to the predetermined front end position Pβ in the front direction DF, the first shaft member 41 inclines in front direction DF with respect to the vertical direction, as shown in the first phase P1 of FIG. 5. The second shaft member 42 gradually contracts with the turn of the first shaft member 41 toward the front direction DF. The second shaft member 42 contracts to a length that allows the first shaft member 41 to turn in front direction DF with respect to the vertical direction, and contracts the most when the first shaft member 41 turns to a position where the support portion 14 is located at the predetermined front end position Pβ. In this state, the second shaft member 42 diagonally extends from the front side of the first shaft member 41 toward the rear direction DB with respect to the first shaft member 41, and is in posture for supporting the first shaft member 41 in a forward leaning posture. As a result, the shaft portion 12 can sufficiently receive the load received from the user J who bends forward.

On the other hand, when the support portion 14 is located in the standing position PB, the first shaft member 41 extends in the vertical direction (FIG. 5: standing state). In this state, the second shaft member 42 extends diagonally. As a result, if a load in the front direction DF is applied from the support portion 14 to the shaft portion 12, the second shaft member 42, which extends diagonally from the front direction DF to the rear direction DB, receives a part of the load. This makes it possible to prevent the part of the base portion 10 on the rear direction DB side from rising.

The present embodiment produces the following effects.

The standing-up assist device 1 of the present embodiment includes: a base portion 10; a shaft portion 12 extending upward from the base portion 10 and being expandable and contractible; a support portion 14, provided at an upper end portion 12U of the shaft portion 12, for supporting a body of a user J. Further, the shaft portion 12 has two shaft members, a first shaft member 41 and a second shaft member 42, which are arranged in the front-rear direction.

According to this configuration, if the user J bends forward and a load on the front direction DF is applied to the support portion 14 in the first phase P1 (section F4A), it is also possible to prevent the part of the base portion 10 on the rear direction DB side (wheel 34 located in the rear direction DB) from rising, and enhance the balance stability. Further, since the torque received by the shaft portion 12 can be dispersed to the first shaft member 41 and the second shaft member 42, a larger torque can be received.

In the standing-up assist device 1 of the present embodiment, the lower end portions 41AD and 42AD of the first shaft member 41 and the second shaft member 42 respectively have turning shafts O1 and O2 for turning in the front-rear direction.

With this configuration, the support portion 14 can be largely moved along the arc E having a turning radius corresponding to the height of the shaft portion 12.

Further, the support portion 14 does not need to be turnably fixed to the upper end portion 12U of the shaft portion 12. Therefore, the support portion 14 can be immovably fixed to the shaft portion 12, and thereby the hand of the user J can be prevented from being caught in the turn of the support portion 14 with respect to the shaft portion 12.

In the standing-up assist device 1 of the present embodiment, the support portion 14 is moved along the fourth trajectory F4 between the sitting position PA and the standing position PB by expansion and contraction, and turn of the shaft portion 12. Here, the fourth trajectory F4 includes: a section F4A extending from the sitting position PA to a predetermined front end position PP in the front direction DF beyond the position Pα directly under the standing position PB; and sections F4B and F4C extending upward from the predetermined front end position Pβ.

According to this configuration, when the user J stands up, he/she can bend his/her body to the front direction DF and take a posture in which his/her center of gravity is sufficiently brought to the front direction DF, and he/she can stand up with the same standing-up motion as a healthy person.

In the standing-up assist device 1 of the present embodiment, the shaft portion 12 includes a first shaft member 41, and a second shaft member 42 provided in the front direction DF with respect to the first shaft member 41. Further, the first shaft member 41 includes a rod 41B moving linearly in the up-down direction, and an outer cylinder 41A in which the rod 41B is housed. An end of the second shaft member 42 is coupled to the outer cylinder 41A of the first shaft member 41.

This configuration makes it possible to largely move the support portion 14 using the turn, and expansion and contraction of the first shaft member 41 while reducing the amount of expansion and contraction of the second shaft member 42 required for this movement.

In the standing-up assist device 1 of the present embodiment, the second shaft member 42 contracts to a length at which the first shaft member 41 is turnable in the front direction DF with respect to the vertical direction.

This configuration makes it possible to make the first shaft member 41 turnable in the front direction DF with respect to the vertical direction, and place the support portion 14 at the predetermined front end position Pβ. Further, this configuration makes it possible to support the first shaft member 41 in the forward leaning posture with the second shaft member 42, and sufficiently receive the load of the user J on the shaft portion 12.

In the standing-up assist device 1 of the present embodiment, the second shaft member 42 extends diagonally while the first shaft member 41 extends in the vertical direction (FIG. 5: standing state).

According to this configuration, if a load to the front direction DF is applied from the support portion 14 to the shaft portion 12, the second shaft member 42 extending diagonally from the front direction DF to the rear direction DB receives a part of the load. This makes it possible to prevent the part of the base portion 10 on the rear direction DB side from rising.

The standing-up assist device 1 of the present embodiment includes a drive unit 51 for turning the shaft portion 12. Further, actuators (first actuator 51A, second actuator 52B) included in the drive unit 51 are arranged on the side of lower end portion of the shaft portion 12.

This configuration makes it possible to lower the center of gravity of the standing-up assist device 1 and enhance the stability degree.

The above-described embodiment is an example of one aspect of the present invention, and can be modified and applied without departing from the spirit of the present invention in any manner.

In the above-described embodiment, the shaft portion 12 may include three or more shaft members in the front-rear direction. Further, the shaft portion 12 may include shaft members arranged in the left-right direction in addition to the shaft members arranged in the front-rear direction.

In the above-described embodiment, the chest contact support portion 36 may include a load sensor to prevent the chest contact support portion 36 from pressing the body of the user J in sitting-down motion. In this case, when the load sensor detects the load on the chest contact support portion 36 due to contact with the user J while the control unit 56 controls the drive unit 51 to assist sitting-down motion, the control unit 56 stops driving by the drive unit 51.

Unless otherwise specified, the horizontal and vertical directions and individual numerical values, shapes, and materials in the above-described embodiments include a range (called a range of equivalents) including those producing the same effects as the directions, numerical values, shapes, and materials.

[Configuration Supported by the Above Embodiment]

The above embodiments are specific examples of the following configurations.

### (Configuration 1)

A standing-up assist device, including: a base portion; a shaft portion extending upward from the base portion, the shaft portion being expandable and contractible; and a support portion, provided at an upper end portion of the shaft portion, for supporting a body of a user, wherein the shaft portion has a plurality of shaft members arranged in a front-rear direction.

The configuration 1 makes it possible to enhance the balance stability against the load due to the user.

### (Configuration 2)

The standing-up assist device according to configuration 1, wherein a turning shaft for turning in a front-rear direction is provided at a lower end portion of each of the plurality of shaft members.

The configuration 2 makes it possible to increase the movement range of the support portion.

### (Configuration 3)

The standing-up assist device according to configuration 2, wherein a sitting position corresponds to a position of a user in a sitting posture, a standing position corresponds to the user in a standing posture, the support portion is moved by expansion and contraction, and turn of the shaft portion, a trajectory is formed when the support portion is moved between the sitting position and the standing position, and the trajectory includes: a first section extending from the sitting position to a predetermined front end position in a front direction beyond a position directly under the standing position; and a second section extending upward from the predetermined front end position.

The configuration 3 allows the user to bend his/her body forward in standing up, and meet himself/herself with the posture in which his/her center of gravity is sufficiently moved forward.

### (Configuration 4)

The standing-up assist device according to any of configurations 1 to 3, wherein the plurality of shaft members includes: a first shaft member provided with the support portion at an end, the first shaft member being expandable and contractible; and a second shaft member provided in front of the first shaft member, the second shaft member being expandable and contractible, the first shaft member includes a rod moving linearly in an up-down direction, and an outer cylinder in which the rod is housed, and an end of the second shaft member is coupled to the outer cylinder of the first shaft member.

The configuration 4 makes it possible to largely move the support portion with the turn, and expansion and contraction of the first shaft member, while reducing the amount of expansion and contraction of the second shaft member required for this movement.

### (Configuration 5)

The standing-up assist device according to configuration 4, wherein the second shaft member contracts to a length at which the first shaft member is turnable in a front direction with respect to a vertical direction.

The configuration 5 makes it possible to make the first shaft member turnable in front direction with respect to the vertical direction, and support the first shaft member in the forward leaning posture with the second shaft member.

### (Configuration 6)

The standing-up assist device according to configuration 4 or 5, wherein the second shaft member extends diagonally while the first shaft member extends in a vertical direction.

The configuration 6 makes it possible to prevent the rear side of the base portion from rising.

### (Configuration 7)

The standing-up assist device according to any of configurations 1 to 6, further including a drive unit for turning the shaft portion, wherein the drive unit is provided on a side of a lower end portion of the shaft portion.

The configuration 7 makes it possible to lower the center of gravity of the standing-up assist device and enhance the stability degree.

### REFERENCE SIGNS LIST

1 standing-up assist device
10 base portion
12 shaft portion
12D lower end portion
12U upper end portion
14 support portion
16 grip portion
24 wheel
31 elbow contact portion
33 elbow contact support member
36 chest contact support portion
41 first shaft member
41A outer cylinder
41B rod
42 second shaft member
50 control system
51 drive unit
56 control unit
F4 fourth trajectory
F4A section (first section)
F4B, F4C section (second section)
J user
O1, O2 turning shaft
PA sitting position
PB standing position
Pβ predetermined front end position

What is claimed is:

1. A standing-up assist device, comprising:
a base portion;
a shaft portion extending upward from the base portion, the shaft portion being expandable and contractible; and
a support portion, provided at an upper end portion of the shaft portion, for supporting a body of a user,
wherein the shaft portion has a plurality of shaft members arranged in a front-rear direction.

2. The standing-up assist device according to claim 1, wherein
a turning shaft for turning in a front-rear direction is provided at a lower end portion of each of the plurality of shaft members.

3. The standing-up assist device according to claim 2, wherein
a sitting position corresponds to a position of a user in a sitting posture, a standing position corresponds to the user in a standing posture, the support portion is moved by expansion and contraction, and turn of the shaft portion, a trajectory is formed when the support portion is moved between the sitting position and the standing position, and the trajectory includes:
a first section extending from the sitting position to a predetermined front end position in a front direction beyond a position directly under the standing position; and
a second section extending upward from the predetermined front end position.

4. The standing-up assist device according to claim 1, wherein
the plurality of shaft members includes:
a first shaft member provided with the support portion at an end, the first shaft member being expandable and contractible; and
a second shaft member provided in front of the first shaft member, the second shaft member being expandable and contractible,
the first shaft member includes
a rod moving linearly in an up-down direction, and
an outer cylinder in which the rod is housed, and
an end of the second shaft member is coupled to the outer cylinder of the first shaft member.

5. The standing-up assist device according to claim 4, wherein
the second shaft member contracts to a length at which the first shaft member is turnable in a front direction with respect to a vertical direction.

6. The standing-up assist device according to claim 4, wherein
the second shaft member extends diagonally while the first shaft member extends in a vertical direction.

7. The standing-up assist device according to claim 1, further comprising a drive unit for turning the shaft portion,
wherein the drive unit is provided on a side of a lower end portion of the shaft portion.
